(19) United States
(12) Patent Application Publication
(10) Pub. No.: US 2020/0198945 A1
(43) Pub. Date: Jun. 25, 2020

(54) PIVOTABLE HYDRAULIC TELESCOPIC SUPPORTING LEG FOR A MOBILE LAND TRANSPORTING OR WORKING MACHINE AND MOBILE TRANSPORTING OR WORKING MACHING COMPRISING SUCH LEG

(71) Applicant: TAJFUN LIV, PROIZVODNJA IN RAZVOJ D.O.O., Postojna (SI)

(72) Inventor: Urban KOLENC, Postojna (SI)

(21) Appl. No.: 16/612,536

(22) PCT Filed: May 24, 2018
(86) PCT No.: PCT/SI2018/000010

§ 371 Date: Nov. 11, 2019

(30) Foreign Application Priority Data
May 30, 2017 (SI) P-201700150

(51) Int. Cl. B66F 3/28; B66C 23/80

(52) U.S. Cl. CPC B66F 3/28; B66C 23/80

(57) ABSTRACT

The present disclosure provides supporting leg for a mobile land transporting machine such as a truck crane that is connectable with each beam on the chassis of the mobile transporting machine and telescopically extendable by means of a hydraulic media in a hydraulic circuit that extends from the beam towards the supporting leg. The supporting leg is, despite to the presence of the hydraulic circuit, pivotable at any angle around each axis on the beam. As such, the presence of any loose hydraulic conduits or other components of the hydraulic circuit that could protrude into the supporting leg and/or the beam is eliminated. To this aim, the supporting leg includes a ring-shaped hydraulic interface with flat front surfaces and an uninterrupted external circumferential surface and located adjacent to a bearing casing of the supporting leg and pivotally located on a hinge of each telescopic arm of the beam.

### CROSS-REFERENCE TO RELATED APPLICATIONS

This application is a United States national phase application of co-pending international patent application number PCT/SI2018/000010, filed on May 24, 2018, which claims the benefit of Slovenia Patent Application No. P-201700150, filed on May 30, 2017, which are hereby incorporated by reference in their entirety.

### BACKGROUND

The present disclosure refers to a pivotable hydraulic telescopic supporting leg for a mobile land transporting or working machine, in particular for a hydraulic truck crane, and simultaneously also to a mobile land transporting or a working machine as such, if it is furnished with at least one supporting leg of such kind. Pursuant to the International Patent Classification such inventions belong either to class B 66C 23/80 or to class B 66C 13/12.

In this, the expression “mobile land transporting machine” means a device, which is suitable for transporting, e.g. reloading, hoisting or transferring of material in form of pieces or particles, wherein such device is mounted to a suitable chassis, which can be by means of a suitable driving means transported by land from certain place to any other location. During exploitation of such mobile transporting machine, the chassis of which is furnished with wheels and is therefore suitable for roadway transporting, namely by hoisting or transferring of heavier loads, said chassis as such often cannot assure a sufficient stability of such machine as a whole, since the arrangement of wheels and loading capability of the machine usually cannot allow transferring of heavy loads, which sometimes may even exceed the weight of the machine as itself, so that at least one at least approximately horizontal beam must mounted on the chassis, and said beam is usually telescopically extendable and furnished with at least one supporting leg located on the end portion thereof, wherein said leg is usually also telescopically extendable. Consequently, as soon as such machine is together with said chassis transferred to each desired location, a telescopic arm of said at least one horizontal beam is extracted, upon which a telescopic arm of said supporting leg mounted on the free end portion of said telescopic arm is extracted towards the ground. As soon as the supporting leg is rest on the ground, the chassis is released of loads, upon which practically the complete load is transferred to the ground via each used supporting legs. The number of supporting legs is determined depending on each particular requirements related to stability of the machine during hoisting and transferring of loads by taking into account also each particular distance of the load apart of the chassis. Thanks to said telescopic concept of said beams and supporting legs, on the one hand, the distance between the points, in which the load is supported on the ground, can be essentially enlarged in order to assure each required stability against overturning of the load during hoisting or transferring thereof, and on the other hand, such transporting machine can also be despite to uneven ground properly tilted and positioned in a suitable level. To this aim, e.g. by a truck crane, two transversal and parallel to each other extending beams are usually sufficient, if they are properly spaced apart of each other in the longitudinal direction of the truck below each transporting device, and each of them is on the free end portion of each of its telescopic arm furnished with a supporting leg, which can be pivoted from its first position, which allows e.g. a roadway transport, into a second position, in which it is rest on each disposable ground. In such machines, at least in the area of said beam as well as in the area of said supporting leg at least a part of a suitable hydraulic circuit is available, so that the hydraulic media can flow from the area of the beam towards the area of the supporting leg, or vice versa. Namely, before each displacement of the machine from one to any other location, such machine must be adapted to requirements dictated by land transporting, which means on the one hand shortening each supporting leg to its shortest state and on the other hand also pivoting of each supporting leg to a suitable distance apart from the ground, namely at least for 90° or even for 180°, and upon that, also shortening of each beam in order to prevent each excessive protruding of the beam from the external dimensions of the vehicle, which would otherwise hinder each regular roadway transporting of such machine.

The expression “working machine” means a device, which is not intended just for transporting of load in form of pieces or particles, but is also suitable for performing of various working operations, which however due to performing of a required stability dictate the use of supporting legs of the previously described art. Such working machine is e.g. an excavator, a scrapper, a drilling machine, a pillar punching machine or similar mobile working machine, which at least from time to time needs to be stabilized by means of resting on the ground by using at least one supporting leg of the previously described art.

Consequently, the present disclosure is based on a problem, how to conceive a supporting leg for a mobile land transporting or working machine, which should be mechanically connectable with each belonging beam on the chassis of each disposable mobile transporting machine and should be telescopically extendable by means of a hydraulic media in each disposable hydraulic circuit, which extends from the area of said beam towards the area of said supporting leg, or vice versa, while at the same time said supporting leg should also be, despite to the presence of said hydraulic circuit, at each desired and unlimited angle pivotable around each desired geometric axis on said beam, by which the presence of any loose hydraulic conduits or any other components of the hydraulic circuit, which could anyhow protrude into the area of said supporting leg and/or said beam, should also be eliminated.

Hydraulic supporting legs as such are known and are commonly used e.g. by truck cranes. In general, such leg comprises an essentially tubular housing, which is blinded on its first end portion, while a telescopic arm is inserted into its open second end portion, and a resting plate with enlarged resting surface is usually available on the free end portion of said arm. A hydraulic cylinder is integrated within the supporting leg, and one part thereof, either a cylinder or a piston rod, is mechanically connected with said housing, while the other part thereof is connected with said telescopic arm. The housing of such supporting leg is pivotally connected with the beam, which is mounted on the chassis of a vehicle, on which the crane is mounted. The crane is usually furnished with two telescopically conceived beams, and each of them comprises a tubular housing, which is open on both end portions, and on each end portion a telescopic arm is inserted into said housing. Each of said telescopic arms of the beam is displaceable by means of a hydraulic cylinder, the first part of which, either a cylinder or a piston rod, is mechanically connected with a housing, while the other part is connected with said telescopic arm, on which a supporting leg is pivotally attached. At least one hydraulic circuit needs to be available for the purpose of displacing said telescopic arms and said circuit comprises appropriate hydraulic media, a hydraulic pump for generating pressure of said media, as well as a control assembly for controlling the hydraulic media by flowing into each particular hydraulic cylinder or out of it. Consequently, such hydraulic circuit must enable hydraulic media to flow from the area of each beam to the area of said supporting leg, which is however due to said requirement in view of pivoting of the supporting leg sometimes pretty complicated. In most of state of the art transporting machines this problem is solved by means of flexible hydraulic conduits, through which the hydraulic media can flow at least in the area of connecting each supporting leg to each corresponding beam, by which usually two conduits are required, namely a supplying one and a draining one, the cross-sections of which due to capability of providing a sufficient quantity of said media also need to be pretty bulky, and in addition to that, due to enabling of the required pivoting of such supporting leg said conduits must also be sufficiently loose and consequently pretty long. Moreover, said hydraulic conduits are each per se connected both to the beam and the supporting leg by means to outwardly protruding hydraulic connectors. Although the conduits are flexible, they are relatively thick and filled with highly pressurized hydraulic media, so that in the practice said expected flexibility is essentially reduced. Of that reason in the practice said hydraulic conduits usually expel a tendency forming of a loop protruding away from the supporting leg and the beam, which leads to serious risks in view of hacking said conduits by each surrounding objects, which can lead to defects or even disabling of the hydraulic circuit.

Being aware of the previously described troubles, a supporting leg has been developed, which is disclosed in EP 2 947 039 A1. In such supporting leg at least one of the hydraulic conduits extends along the interior of the beam and through the hinge of the supporting leg towards the hydraulic cylinder, which is integrated within the supporting leg. However, also in such case said conduit is firmly connected with the hydraulic connector on said cylinder, while the supporting leg is pivotable around said hinge. As expressed, the flexibility of the hydraulic conduit is usually essentially reduced due to a required thickness and the pressure within it, so that in fact such supporting leg is pivotable only within a pre-determined and limited angle, which is with respect to the horizontal plane at maximum approximately ±90°, while each further increasing of this angle of pivoting of the supporting leg would unavoidable lead either to inadmissible torsion overloading of the hydraulic conduits or to disabling of hydraulic connectors, which could result in leakage or other damages of the hydraulic circuit.

It should also be annotated, that a crane or any other transporting or working machine is generally—like e.g. various vehicle bodies or cargo platforms or accommodation units—mountable on various chassis of either specially manufactured or commonly used and commercially available vehicles or similar appliances or apparatuses, which are as such suitable for land transporting of cargo e.g. in a public roadway transport. In such concept, each flexibility in view of freely pivoting of the supporting appliances is always welcome and desired. By certain chassis, pivoting of supporting legs at ±45° may be satisfactory, by other chassis e.g. pivoting at ±90° may be sufficient, but by certain chassis it may also happen, that even pivoting at ±180° may be insufficient. Consequently, said possibility of pivoting the supporting leg only within a limited range of the angle is no doubt a deficiency, which ought to be avoided.

The present disclosure refers to a pivotable hydraulic telescopic supporting leg for a mobile land transporting or working machine, in particular for a truck hydraulic crane, wherein such supporting leg consists of a tubular housing, which is blinded on its one side, where at least one hydraulic conduit of a hydraulic circuit is connected thereto, while on its opened end portion a telescopic arm is inserted there-into, which is by means of a hydraulic media available within said hydraulic circuit displaceable to and fro along a geometric axis of the supporting leg. On said blinded end portion of the housing a tubular bearing casing is available, the central axis of which extends perpendicularly with respect to said geometric axis of the supporting leg. Said supporting leg is pivotally connected to a telescopic beam, by which each mobile land transporting or working machine is mounted on a chassis of each disposable land vehicle and which consists of a tubular casing, which is open on both terminal end portions and into which on each end portion a telescopic arm is inserted, which is movable to and fro by means of the hydraulic media available within said hydraulic circuit and is on its free end portion, which protrudes outside from said casing, furnished with a hinge, on which a supporting leg is attached by means of its tubular bearing casing and pivotally around the geometric axis, which extends perpendicularly with respect to said longitudinal axis of the supporting leg, and said leg can be fixed in each desired position.

The present disclosure proposes that said supporting leg comprises a ring-shaped hydraulic interface with flat front surfaces and uninterrupted external circumferential surface. Said hydraulic interface is arranged adjacent to said bearing casing of the supporting leg and is analogously like said casing of the supporting leg itself pivotally placed on the hinge of each corresponding telescopic arm of the beam. Said interface is allowed to be pivoted at each desired angle around said axis of the hinge and relatively to said beam. Said interface is by means of a suitable sealing assembly in the area of both flat front surfaces hydraulically sealed both against said bearing case of the supporting leg as well as against to each belonging hinge on the telescopic arm of the beam. Still further, said hydraulic interface is on its inner cylindrical surface furnished with at least one circumferentially extending and uninterrupted groove, which is arranged at sufficient distance apart of said front surfaces and is adapted to receive a hydraulic media from the hydraulic circuit. Said hydraulic interface is moreover furnished with at least one hydraulic connector, which is arranged in the area of said groove and is on the external surface of said interface connected with a corresponding hydraulic conduit, which is arranged on the supporting leg and belongs to said electric circuit, wherein said hinge is furnished with a transversal passage, through which the hydraulic media is able to flow from the hydraulic circuit towards the area of said groove in said hydraulic interface, or in opposite direction.

In a further possible embodiment said supporting leg comprises a modified hydraulic interface, which is furnished with at least two separate grooves, which are arranged on the internal cylindrical surface of the interface and each per se extend in the circumferential direction thereof and are spaced apart from each other in the axial direction of the interface. Each of said grooves is hydraulically connected on the one hand with at least one hydraulic connector on the external surface of said interface, so that said at least one hydraulic connector is suitable for establishing of a hydraulic connection with the hydraulic conduit of the hydraulic circuit on the supporting leg, and on the other hand also through the passage in the hinge on the beam with each belonging hydraulic conduit on the beam.

In a further possible embodiment of said supporting leg, the last is furnished with two hydraulic interfaces, which are coaxially arranged closely to each other and adjacent to said bearing casing, and each of them is sealed on the hinge of the beam and is freely pivotable around it substantially together with the belonging supporting leg and is moreover adapted to be hydraulically integrated into a hydraulic circuit, at least one conduit of which is adapted for transporting the hydraulic media from the area of the beam towards the area of the supporting leg, and/or vice versa. In such case, at least one of each disposable hydraulic interfaces is furnished with at least two separate grooves, which are arranged on the internal cylindrical surface of the interface and each per se extend in the circumferential direction thereof and are spaced apart from each other in the axial direction of the interface, wherein each of them is hydraulically connected on the one hand with at least one hydraulic connector on the external surface of said interface, by which said at least one hydraulic connector is suitable for establishing of a hydraulic connection with the hydraulic conduit of the hydraulic circuit on the supporting leg, and on the other hand also through the passage in the hinge on the beam with each belonging hydraulic conduit on the beam.

A hydraulic cylinder can be used as a housing of the supporting leg, and is supplied by the hydraulic media from the hydraulic circuit, while its telescopic arm can be a piston rod, which is adapted to cooperate with said cylinder.

The present disclosure also proposes a mobile transporting machine, which comprises at least one supporting leg in accordance with the previously mentioned features. Said mobile transporting machine can be, among others, conceived as a mobile truck hydraulic crane, which comprises at least one telescopic beam, which is mountable onto a chassis of each disposable vehicle, which is foreseen for transporting of said crane to each desired location. Also in such case, said beam consists of a tubular housing, which is open on its both end portions, and wherein on each end portion a telescopic arm is inserted into said housing and is movable to and from by means of the hydraulic media, while on its end portion a hinge is arranged, in the area of which a supporting leg is pivotally attached to said telescopic arm of the beam, and said leg consisting of a tubular housing, which is blinded on its one end portion and into which a telescopic arm is inserted, which is longitudinally displaceable to and from by means of the hydraulic media and a free end portion of which is adapted to be rest on each disposable ground and is optionally furnished with a resting plate furnished with enlarged resting surface. In this, said crane is furnished with at least two supporting legs in accordance with previously described features.

Moreover, a working machine is proposed within the scope of this present disclosure, wherein such machine comprises at least one supporting leg in accordance with previously described features, and wherein such machine furthermore comprises at least one hydraulic circuit, to which said supporting leg is hydraulically connected.

### DRAWINGS

The present disclosure will be described in more detail on the basis of an embodiment, which is presented in the attached drawing, in which

FIG. 1 is a front view of a pivotable hydraulic telescopic supporting leg of a mobile crane as one of possible mobile land transporting devices, namely in its mounted state and prior to use or during the use of such crane;

FIG. 2 is an isometric presentation of a beam of the crane according to FIG. 1, which is furnished with two supporting legs according to the present disclosure;

FIG. 3 is an isometric and explosion view of the beam of the crane according to FIGS. 1 and 2 with corresponding supporting leg according to the present disclosure;

FIG. 4 is an isometric and explosion view of a hydraulic interface of the supporting leg according to the present disclosure; and

FIG. 5 is a detail A according to FIG. 3.

### DETAILED DESCRIPTION

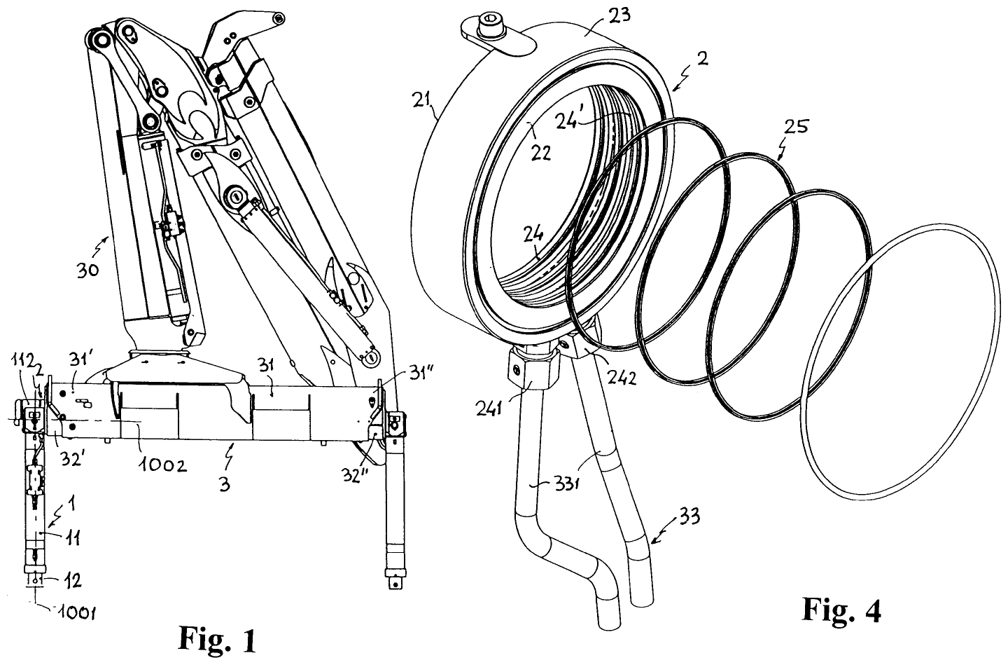

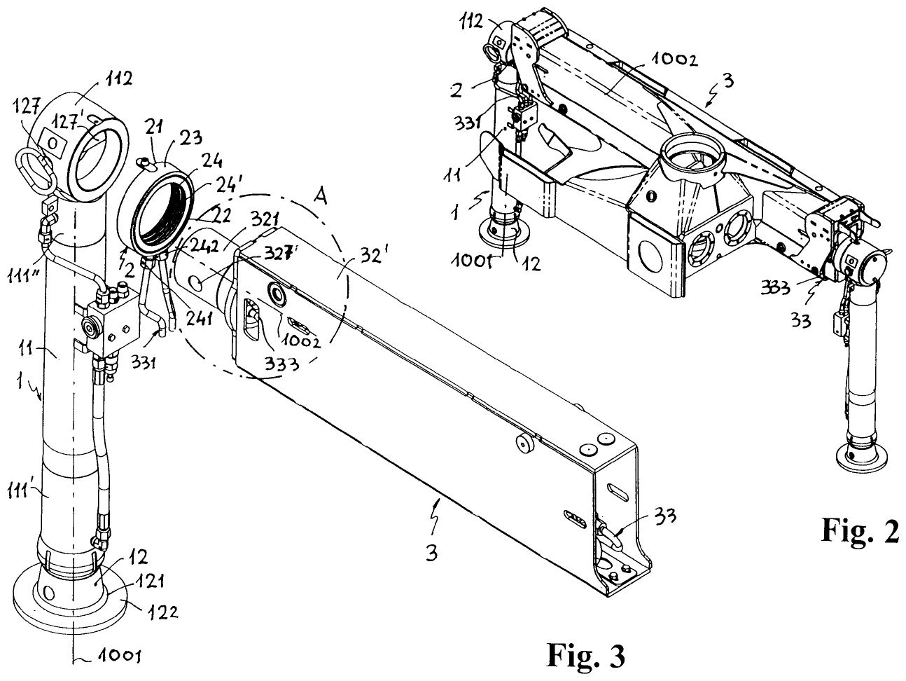

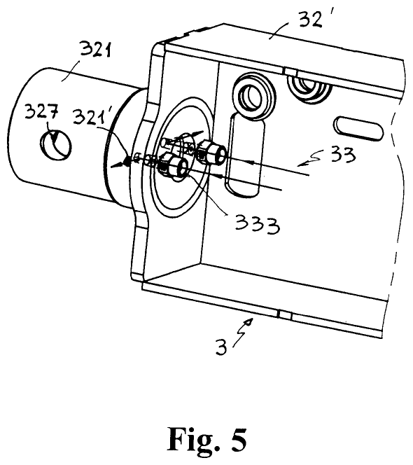

Consequently, FIGS. 2 and 3 present a pivotable hydraulic supporting leg 1 for a mobile land transporting or a working machine, in particular for a truck hydraulic crane 30, which is presented in FIG. 1.

Similarly like the other modern state of the art supporting legs, the supporting leg 1 consists of a tubular housing 11, which is blinded on its one side, where at least one hydraulic conduit 331 of a hydraulic circuit 33 is connected thereto, while on its opened end portion 111′ a telescopic arm 122 is inserted there-into, which is by means of a hydraulic media available within said hydraulic circuit 33 displaceable to and fro along a geometric axis 1001 of the supporting leg 1.

On the blinded end portion 111″ of said housing 11 of the supporting leg 1 a tubular bearing casing 112 is available, the central axis 1002 of which extends perpendicularly with respect to said geometric axis 1001 of the supporting leg 1, namely in this particular case along a beam 3, which will be later-on described in more detail, but in general even transversally with respect to said beam 3, namely perpendicularly with respect to the longitudinal geometric axis thereof.

Said supporting leg 1 is pivotally connected to a telescopic beam 3, by which each mobile land transporting or working machine is mounted on a chassis of each disposable land vehicle, which is not shown in the drawings, and said beam 3 consists of a tubular casing 31, which is open on both terminal end portions and into which on each end portion 31′, 31″ a telescopic arm 32′, 32″ is inserted, which is movable to and fro by means of the hydraulic media available within said hydraulic circuit 33, usually by means of a suitable hydraulic cylinder.

Each telescopic arm 32′, 32″ is on its free end portion 320, which protrudes outside from said casing 31, furnished with a hinge 321, on which a supporting leg 1 is attached by means of its tubular bearing casing 112 and pivotally around the geometric axis 1002, which extends perpendicularly with respect to said longitudinal axis 1001 of the supporting leg 1, and said leg 1 can be fixed in each desired position.

In the shown embodiment according to FIG. 3 said supporting leg 1 can be fixed and secured against undesired pivoting or displacing in two positions, namely in its first position, in which it is faced towards the ground, and in its second position, in which it is faced away from the ground, which is assured by means of a pin 1277, which is insertable through passages 127′ in a bearing casing 112 of the leg 1 and simultaneously through a transversal passage 327 in the bearing 321 of the telescopic arm 32′, 32″ of the beam 3.

The present disclosure proposes that said supporting leg comprises a ring-shaped hydraulic interface 2 with flat front surfaces 21, 22 and uninterrupted external circumferential surface 23, wherein said hydraulic interface 2 is arranged adjacent to said bearing casing 112 of the supporting leg 1 and is analogously like said casing 112 of the supporting leg 1 itself pivotally placed on the hinge 321 of each corresponding telescopic arm 32′, 32″ of the beam 3.

In this, said interface 2 is allowed to be pivoted at each desired angle around said axis 1002 of the hinge 321 and relatively to said beam 3 and is by means of a suitable sealing assembly 25 in the area of both flat front surfaces 21, 22 hydraulically sealed both against said bearing case 112 of the supporting leg 1 as well as against to each belonging hinge 321 on the telescopic arm 32′, 32″ of the beam 3. Besides, said hydraulic interface 2 is on its inner cylindrical surface 24 furnished with at least one circumferentially extending and uninterrupted groove 24′, which is arranged at sufficient distance apart of said front surfaces 21, 22 and is adapted to receive a hydraulic media from the hydraulic circuit 33.

Said hydraulic interface 2 is moreover furnished with at least one hydraulic connector 241, 242, which is arranged in the area of said groove 24′ and is on the external surface 23 of said interface 2 connected with a corresponding hydraulic conduit 331, which is arranged on the supporting leg 1 and belongs to said electric circuit 33, wherein said hinge 321 is furnished with a transversal passage 321′, through which the hydraulic media is able to flow from the hydraulic circuit 33 towards the area of said groove 24′ in said hydraulic interface 2.

Thanks to said interface 2 with at least one groove 24 and each desired number of hydraulic connectors 241, 242 arranged on the external surface 23 thereof, the hydraulic media in the hydraulic circuit 33 is regardless to each current position of the supporting leg permanently allowed to flow freely 1 from the hydraulic conduit 333 in the area of the beam 3 through the passage 321′ in the hinge 321 on the beam 3 and through the connectors 241, 242 and said groove 24′ in the interface 2.

Especially when the hydraulic circuit 33 in the area of the beam 3 and the supporting leg 1 comprises at least two branches, for example the first one for powering the cylinder of the supporting leg 1 and the second one for powering of another independent hydraulic appliance located on the supporting leg 1, said hydraulic interface 2 can be furnished with at least two separate grooves 24′, which are arranged on the internal cylindrical surface 24 of the interface 2 and each per se extend in the circumferential direction thereof and are spaced apart from each other in the axial direction 1002 of the interface 2, wherein each of them is hydraulically connected on the one hand with at least one hydraulic connector 241, 242 on the external surface 23 of said interface 2, so that said at least one hydraulic connector 241, 242 is suitable for establishing of a hydraulic connection with the hydraulic conduit 331 of the hydraulic circuit 33 on the supporting leg 1, and on the other hand also through the passage 321′ in the hinge 321 on the beam 3 with each belonging hydraulic conduit 333 on the beam 3.

In accordance with a further possible embodiment, the supporting leg 1 according to the present disclosure is furnished with two hydraulic interfaces 2, which are coaxially arranged closely to each other and adjacent to said bearing casing 112, and each of them is sealed on the hinge 321 of the beam 3 and is freely pivotable around it substantially together with the belonging supporting leg 1 and is moreover adapted to be hydraulically integrated into a hydraulic circuit 33, at least one conduit 331, 332 of which is adapted for transporting the hydraulic media from the area of the beam 3 towards the area of the supporting leg 1, and/or vice versa. Such embodiment should be taken in consideration in particular when the hydraulic circuit 33, in addition to the hydraulic conduit 331 required for powering of the telescopic supporting leg 1 itself, also comprises at least one further conduit, which is intended for powering of at least one further hydraulic appliance, e.g. of a hydraulic motor or similar hydraulic powering means, which can be located in the area of said supporting leg. In such case, at least one of each disposable hydraulic interfaces 2 is furnished with at least two separate grooves 24′, which are arranged on the internal cylindrical surface 24 of the interface 2 and each per se extend in the circumferential direction thereof and are spaced apart from each other in the axial direction 1002 of the interface 2, wherein each of them is hydraulically connected on the one hand with at least one hydraulic connector 241, 242 on the external surface 23 of said interface 2, so that said at least one hydraulic connector 241, 242 is suitable for establishing of a hydraulic connection with the hydraulic conduit 331 of the hydraulic circuit 33 on the supporting leg 1, and on the other hand also through the passage 321′ in the hinge 321 on the beam 3 with each belonging hydraulic conduit 333 on the beam 3.

Said supporting leg 1 can be easily realized in such manner that a hydraulic cylinder is used as its housing 11, and is supplied by the hydraulic media from the hydraulic circuit 33, while its telescopic arm 12 is a piston rod, which is adapted to cooperate with said cylinder.

A mobile transporting machine, which is shown in FIG. 1, comprises at least one supporting leg 1 according to the present disclosure. The shown machine is a mobile truck hydraulic crane 30 with at least one telescopic beam 3, which is mountable onto a chassis of each disposable vehicle, which is foreseen for transporting of said crane 30 to each desired location, and is furnished with a pair of supporting legs 1 according to the present disclosure. Also in this case, said beam 3 is telescopically conceived and consists of a tubular housing 31, which is open on its both end portions 31′, 31″, and wherein on each end portion 31′, 31″ a telescopic arm 32′, 32″ is inserted into said housing 31 and is movable to and from by means of the hydraulic media. The free end portion 320 of each of said arms 32′, 32″ a hinge 321 is arranged, in the area of which a supporting leg 1 is pivotally attached to said telescopic arm 32′, 32′ of the beam 3, said leg 1 consisting of a tubular housing 11, which is blinded on its one end portion and into which a telescopic arm 12 is inserted, which is longitudinally displaceable to and from by means of the hydraulic media and a free end portion 121 of which is adapted to be rest on each disposable ground and is optionally furnished with a resting plate 122 with enlarged resting surface.

Said supporting leg 1 is quite analogous like in the previously described crane also applicable on working machines like excavators, drilling or similar machines, which during exploitation thereof at least from time to time require a reliable support, either due to providing stability when exposed to loadings, or simply due to positioning thereof in each desired level.

However, each of such working machines within the scope of this present disclosure is furnished with at least one supporting with features, which are disclosed in this specification and also in the claims, and moreover, such working machine must also also furnished with at least one hydraulic circuit 3, to which said supporting leg 1 is hydraulically connected, by which then proper functioning of the supporting leg 1 is enabled.

What is claimed is:

1. A pivotable hydraulic telescopic supporting leg for a mobile land transporting machine, comprising:
a supporting leg including a tubular housing that is blinded on one side; and
at least one hydraulic conduit of a hydraulic circuit connected to the tubular housing,
wherein an opened end portion of the at least one hydraulic conduit includes a telescopic arm that is configured to be actuated via a hydraulic media available within the hydraulic circuit to move along an axis of the supporting leg, and
wherein the blinded side of the tubular housing includes a tubular bearing casing that includes a central axis that extends perpendicularly with respect to the axis of the supporting leg, and
wherein the supporting leg pivotally connected to a telescopic beam that is configured to mount to a mobile land transporting machine and that includes a tubular casing that is open on opposing terminal end portions that are each coupled to a telescopic arm that is configured to be actuated via the hydraulic media available within the hydraulic circuit and that includes an end portion that protrudes outside of a casing that is furnished with a hinge on which the supporting leg is attached via the tubular bearing casing pivotally around the axis of the supporting leg that extends perpendicularly with respect to a longitudinal axis of the supporting leg that is configured to be fixed in one or more desired position, and
wherein the pivotable hydraulic telescopic supporting leg includes
a ring-shaped hydraulic interface with flat front surfaces and an uninterrupted external circumferential surface,
wherein the ring-shaped hydraulic interface is located adjacent to the bearing casing of the pivotable hydraulic telescopic supporting leg and is pivotally placed on the hinge of each corresponding telescopic arm of the telescopic beam, and
wherein the ring-shaped hydraulic interface is configured to be pivoted at desired angles around an axis of the hinge and relative to the telescopic beam and is hydraulically sealed against the bearing casing on the pivotable hydraulic telescopic supporting leg well as against each hinge on the telescopic arm of the telescopic beam, and
wherein the ring-shaped hydraulic interface includes an inner cylindrical surface with at least one circumferentially extending and uninterrupted groove that is spaced apart from front surfaces of the ring-shaped hydraulic interface and is configured to receive the hydraulic media from the hydraulic circuit (33), and
wherein the ring-shaped hydraulic interface includes at least one hydraulic connector located in the area of the groove (24′) and on an external surface of the ring-shaped interface and connected with a corresponding hydraulic conduit on the supporting leg and included in an electric circuit, and
wherein the hinge includes a transversal passage through which the hydraulic media is configured to flow between the hydraulic circuit and the groove in the hydraulic interface.

2. The supporting leg of claim 1, wherein the ring-shaped hydraulic interface includes at least two separate grooves that are arranged on the internal cylindrical surface of the ring-shaped hydraulic interface, and that each extend in a circumferential direction and are spaced apart from each other in an axial direction of the interface, and
wherein each of at least two separate grooves is hydraulically connected with at least one hydraulic connector on the external surface of the ring-shaped hydraulic interface so that the at least one hydraulic connector is configured to establish a hydraulic connection with the hydraulic conduit of the hydraulic circuit on the supporting leg, as well as a hydraulic connection through the passage in the hinge on the beam with each hydraulic conduit on the beam.

3. The supporting leg of claim 1, wherein with the supporting leg includes two hydraulic interfaces that are coaxial to each other and located adjacent to the bearing casing, and wherein each of the hydraulic interfaces is sealed on the hinge of the beam, is freely pivotable around the beam, and is configured to be hydraulically integrated into the hydraulic circuit, and wherein at least one conduit is configured to transport the hydraulic media between the beam and the supporting leg.

4. The supporting leg of to claim 3, wherein at least one of each of the hydraulic interfaces includes at least two separate grooves that are arranged on the internal cylindrical surface of the ring-shaped hydraulic interface and that extend in a circumferential direction and are spaced apart from each other in an axial direction of the ring-shaped hydraulic interface, wherein each of the at least two separate grooves is hydraulically connected with at least one hydraulic connector on the external surface of the ring-shaped hydraulic interface so that the at least one hydraulic connector is configured to establish a hydraulic connection with the hydraulic conduit of the hydraulic circuit on the supporting leg, and through the passage in the hinge on the beam with each hydraulic conduit on the beam.

5. The supporting leg of claim 1, wherein a hydraulic cylinder is provided as a housing for the supporting leg and is supplied with the hydraulic media from the hydraulic circuit, and wherein it's the telescopic arm is a piston rod that is configured to cooperate with the hydraulic cylinder.

6. The supporting leg of claim 1, further comprising:
a mobile transporting machine including the supporting leg.

7. The supporting leg of claim 1, wherein: the mobile transporting machine is a mobile truck hydraulic crane including:
at least one telescopic beam that is configured to mount onto a chassis of a vehicle that is configured to transport the mobile truck hydraulic crane, wherein the beam includes of a tubular housing that is open on opposing end portions that each include a telescopic arm inserted into the tubular housing and configured to move by means of the hydraulic media, while the end portion includes a hinge pivotally attached to the telescopic arm of the beam (3), and wherein the supporting leg includes a tubular housing that is blinded on an end portion and into which a telescopic arm is inserted that is longitudinally displaceable by means of the hydraulic media, and that includes a free end portion that is configured to engage ground and that includes a resting plate.

8. The supporting leg of claim 1, further comprising:
a working machine including the supporting leg and the at least one hydraulic circuit connected to the supporting leg.
